(19) United States
(12) Patent Application Publication
(10) Pub. No.: US 2016/0105070 A1
(43) Pub. Date: Apr. 14, 2016

(54) MOUNTING BRACKET FOR MOTOR CAPACITOR AND MOTOR ASSEMBLY EQUIPPED WITH MOTOR CAPACITOR MOUNTED TO A MOTOR BODY USING SUCH MOUNTING BRACKET

(71) Applicant: GECKO ALLIANCE GROUP INC., Quebec (CA)

(72) Inventors: Benoit LAFLAMME, Quebec (CA); Paul ISABELLE, Quebec (CA)

(21) Appl. No.: 14/528,457

(22) Filed: Oct. 30, 2014

(30) Foreign Application Priority Data
Oct. 9, 2014 (CA) 2866863

(51) Int. Cl. H02K 5/22; H02K 11/00; F16M 13/02

(52) U.S. Cl. CPC H02K 5/22; F16M 13/022; H02K 11/0094

(57) ABSTRACT

A motor assembly comprising a motor body having a generally cylindrical outer surface on which is mounted a capacitor via a mounting bracket is provided. The mounting bracket has a generally arcuate member engaged with the generally cylindrical outer surface of the motor body and allows the capacitor to be positioned at different angles along a circumference of the motor body by rotating the mounting bracket about the generally cylindrical outer surface of the motor body.

### FIELD OF THE INVENTION

The invention generally relates to electric motors and, more particularly, to mounting brackets for mounting capacitors to motor bodies or shells and to motors equipped with capacitors mounted using such mounting brackets.

### BACKGROUND

Electric motors are used to convert electrical energy to mechanical energy in a wide range of applications (e.g., water pumps, fans, blowers, machine/power tools, household appliances, etc.). Most electric motors operate through the interaction between a magnetic field and currents to generate forces within the motor. Typically, a rotor (the moving part) has conductors laid into it which carry currents that interact with the magnetic field of windings of a stator (the stationary part) to generate the forces that turn a shaft to deliver mechanical power. In some applications, an electric motor may be equipped with a motor capacitor (e.g., a start capacitor and/or a run capacitor) to alter the currents to the windings of the stator to create a rotating magnetic field. The use of a motor capacitor may in some cases increase the efficiency of the motor. Some typical applications in which motor capacitors may be utilized in connection with electric motors include air conditioners, water pumps (of the type that may be used in spas or pools for example), fans, washing machines, and capacitor-start-capacitor-run motors.

Motors are typically placed within housings of the devices they operate and must often share limited space with other components of these devices. In some configurations, motor capacitors are secured to outer surfaces of the motor bodies or shells and thus occupy space that project outwards from the motor bodies or shells. With this in mind, the position of the motor capacitor on the motor body or shell may be a factor to consider when the motor is to be integrated into a confined space. In particular depending on the shape and size of the space within which the motor must fit, different motors having motor capacitors located at different positions on the motor body or shell may be required.

By way of example, spa systems and hot tubs have limited space for accommodating devices such as pump motors. In particular, a pump motor must generally fit underneath the spa skirt and share such confined space with other components of the spa system, including the heater, circulation pipes and the like. If a pump motor does not have a suitable shape, it may be challenging to position it in the limited available space. In order to address such constraints, pump motors are typically manufactured with the motor capacitor positioned at different locations. A particular pump motor is selected in part taking into account the position of its motor capacitor. As a result, in order to meet their customer's needs, spa pump manufacturers are usually required to offer (and keep on inventory) multiple types of pump motors having motor capacitors positioned at different locations, which is often a costly and undesirable approach. In addition, once a customer orders a particular pump motor having its motor capacitor positioned at a specific location, there is no suitable or convenient way of adapting such pump motor should the customer's original selection proves to not have been the most suitable in the particular applications.

In light of the above, there is a need in the industry to provide a motor assembly that alleviates at least part issues related to space constraints of the type described above.

### SUMMARY

In accordance with a first aspect, a motor assembly is provided comprising a motor body having a generally cylindrical outer surface on which is mounted a capacitor via a mounting bracket. The mounting bracket has a generally arcuate member engaging the generally cylindrical outer surface of the motor body and allows the capacitor to be positioned at different angles along a circumference of the motor body by rotating the mounting bracket about the generally cylindrical outer surface of the motor body.

In some specific implementations, the mounting bracket may be fastened to the motor body using at least one mechanical fastener, which may include one or more screws, thereby positioning the capacitor at a specific angle along the circumference of the motor body. In a non-limiting example, the mounting bracket may be fastened to the motor body using a single screw.

In specific implementations, the mounting bracket may include at least two apertures formed along the generally arcuate member, the at least two apertures including a first aperture and a second aperture configured for receiving therein the mechanical fastener.

In specific practical implementations, the mounting bracket may be fastened to the motor body for example by a screw engaging one of the at least two apertures of the mounting bracket and a complementary aperture formed on the outer surface of the motor body. More specifically, in embodiments in which the generally cylindrical outer surface of the motor body has an aperture formed thereon:
a. to position the capacitor at a first specific angle along the circumference of the motor body, the mounting bracket may be rotated about the generally cylindrical outer surface of the motor body in order to align the first aperture of the mounting bracket with the at least one aperture defined on the outer surface of the motor body; and
b. to position the capacitor at a second specific angle along the circumference of the motor body, the mounting bracket may be rotated about the generally cylindrical outer surface of the motor body in order to align the second aperture of the mounting bracket with the at least one aperture defined on the outer surface of the motor body.

It is to be appreciated that while the above specific implementations have been described as including two or more apertures, alternative embodiments may include any suitable number of apertures formed on the along the generally arcuate member, include three or more, four or more aperture and the like. The number and location of the apertures along the along the generally arcuate member may allow the capacitor to be positions at different corresponding angles along the circumference of the motor body. The apertures may be spaced at a generally regular interval along the arcuate member of the mounting bracket or may be spaced at irregular intervals depending on the positions along the circumference of the motor body that the bracket may be designed to accommodate.

Optionally, guiding rails may be defined on the generally cylindrical outer surface of the motor body to facilitate the position and rotation of the mounting bracket about the generally cylindrical outer surface of the motor body.

Optionally still, an inner surface of the generally arcuate member of the mounting bracket may define guiding rails configured for matingly engaging corresponding guiding rails defined on the generally cylindrical outer surface of the motor body. According to a specific implementation of such a variant, the guiding rails of the arcuate member of the mounting bracket may be oriented longitudinally along at least one side of the inner surface of the generally arcuate member and the corresponding guiding rails defined on the generally cylindrical outer surface of the motor body may be oriented along at least a portion of the circumference of the motor body to facilitate rotation of the mounting bracket about the generally cylindrical outer surface of the motor body.

Optionally still, an inner surface of the generally arcuate member of the mounting bracket may define one or more positioning members configured for engaging corresponding positioning members defined on the generally cylindrical outer surface of the motor body. According to a specific implementation of such a variant, the one or more positioning members of the arcuate member include at least one elongated member extending generally transversely across the inner surface of the arcuate member and the positioning members defined on the generally cylindrical outer surface of the motor body are oriented transversely to the circumference of the motor body to facilitate positioning of the mounting bracket to the motor body.

In a specific implementation, the mounting bracket further comprises a capacitor housing member for releasable engaging the capacitor.

Practical implementations of the above described motor assembly may be configured for a plurality of different specific applications including, without being limited to, air conditioners, water pumps (for e.g. of the type that may be used in spas or pools), fans, washing machines, and capacitor-start-capacitor-run motors.

In accordance with another aspect, a mounting bracket for a motor capacitor is provided. The mounting bracket is configured to be used in a motor assembly having a motor body with a generally cylindrical outer surface and comprises a generally arcuate member for engaging the generally cylindrical outer surface of the motor body to allow the capacitor to be positioned at different angles on the motor body by rotating the mounting bracket about the generally cylindrical outer surface of the motor body.

In some specific implementations, the mounting bracket may be configured to be fastened to the motor body using at least one mechanical fastener, which may include one or more screws, to position the capacitor at a specific angle along the circumference of the motor body. In a non-limiting example, the mounting bracket may be fastened to the motor body using a single screw.

In specific implementations, the mounting bracket may include at least two apertures formed along the generally arcuate member, the at least two apertures including a first aperture and a second aperture configured for receiving therein the mechanical fastener. In specific practical implementations, the mounting bracket may be configured to be fastened to the motor body by a screw engaging one of the at least two apertures of the mounting bracket and a complementary aperture formed on the outer surface of the motor body.

It is to be appreciated that while the above specific implementations have been described as including two or more apertures, alternative embodiments may include any suitable number of apertures formed on the along the generally arcuate member, include three or more, four or more aperture and the like. The number and location of the apertures along the along the generally arcuate member may allow the capacitor to be positions at different corresponding angles along the circumference of the motor body. The apertures may be spaced at a generally regular interval along the arcuate member of the mounting bracket or may be spaced at irregular intervals depending on the positions along the circumference of the motor body that the bracket may be designed to accommodate.

Optionally, an inner surface of the generally arcuate member of the mounting bracket may define guiding rails configured for matingly engaging corresponding guiding rails defined on the generally cylindrical outer surface of the motor body. According to a specific implementation of such a variant, the guiding rails of the arcuate member of the mounting bracket may be oriented longitudinally along at least one side of the inner surface of the generally arcuate member.

Optionally still, an inner surface of the generally arcuate member of the mounting bracket may define one or more positioning members configured for engaging corresponding positioning members defined on the generally cylindrical outer surface of the motor body. According to a specific implementation of such a variant, the one or more positioning members of the arcuate member may include at least one elongated member extending generally transversely across the inner surface of the arcuate member.

In a specific implementation, the mounting bracket further comprises a capacitor housing member for releasable engaging the capacitor.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1A shows a perspective view of a mounting bracket in which may be mounted a motor capacitor in accordance with a first specific embodiment.

FIG. 1B shows a perspective view of an inner surface of the mounting bracket shown in FIG. 1A in accordance with a non-limiting example of implementation.

FIG. 1C shows the perspective view of the inner surface of the mounting bracket shown in FIG. 1B in which a capacitor has been positioned in accordance with a non-limiting example of implementation.

FIG. 2 shows a non-limiting example of a motor body or shell to which a mounting bracket of the type shown in FIGS. 1A and 1B may be mounted;

FIG. 3 shows a perspective view of a motor assembly including the motor body or shell shown in FIG. 2 and the mounting bracket shown in FIGS. 1A and 1B, wherein the mounting bracket engages the motor body or shell in a first (forward) orientation and at a first angle.

FIGS. 4A to 4D show perspective views of the motor assembly of FIG. 3 showing the mounting bracket engaging the motor body or shell in a first (forward) orientation at different angles in accordance with a specific example of implementation.

FIGS. 5A and 5B shows a perspective view of the motor assembly of FIG. 3 with the mounting bracket of FIG. 1 engaging the motor body or shell in the first (forward) and a second (reverse) orientations, respectively, in accordance with a specific embodiment.

FIG. 6 shows a perspective view of a mounting bracket in which may be mounted a motor capacitor in accordance with a second specific embodiment.

FIG. 7 shows a perspective view of a motor assembly including the motor body or shell shown in FIG. 2 and the mounting bracket shown in FIG. 6.

FIG. 8A shows a perspective view of an inner surface of the mounting bracket of the type shown in FIG. 1A in accordance with a first variant.

FIG. 8B shows a non-limiting example of a motor body or shell to which a mounting bracket according to the variant shown in FIG. 8A may be mounted;

FIG. 8C shows a perspective view of a motor assembly including the motor body or shell shown in FIG. 8B and the mounting bracket shown in FIG. 8A, wherein the mounting bracket engages the motor body or shell in a first (forward) orientation.

FIG. 9A shows a perspective view of an inner surface of the mounting bracket of the type shown in FIG. 1A in accordance with a second variant.

FIG. 9B shows a non-limiting example of a motor body or shell to which a mounting bracket according to the variant shown in FIG. 9A may be mounted;

FIG. 9C shows a perspective view of a motor assembly including the motor body or shell shown in FIG. 9B and the mounting bracket shown in FIG. 9A, wherein the mounting bracket engages the motor body or shell in a first (forward) orientation.

FIG. 10A shows a non-limiting example of a motor body or shell to which a mounting bracket of the type shown in FIG. 1A may be mounted in accordance with yet another variant;

FIG. 10B shows a perspective view of a motor assembly including the motor body or shell shown in FIG. 10A and the mounting bracket of the type shown in FIG. 1A, wherein the mounting bracket engages the motor body or shell in a first (forward) orientation.

In the drawings, embodiments of the invention are illustrated by way of example. It is to be expressly understood that the description and drawings are only for the purpose of illustrating certain embodiments of the invention and are an aid for understanding. They are not intended to be a definition of the limits of the invention.

### DETAILED DESCRIPTION

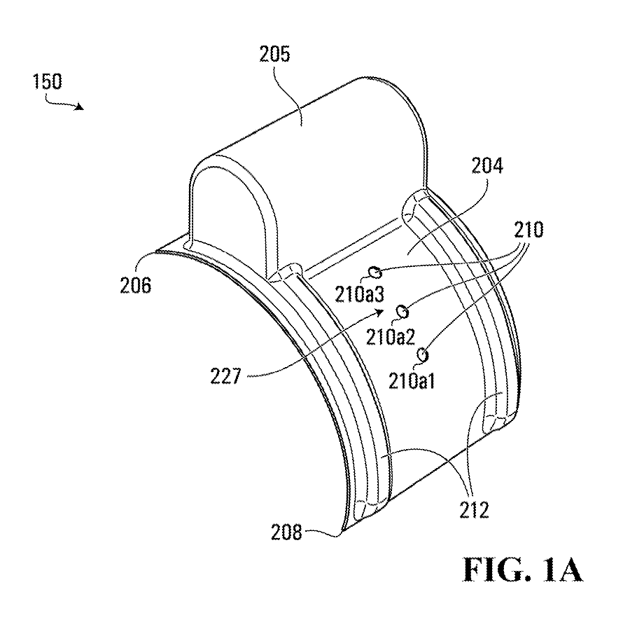

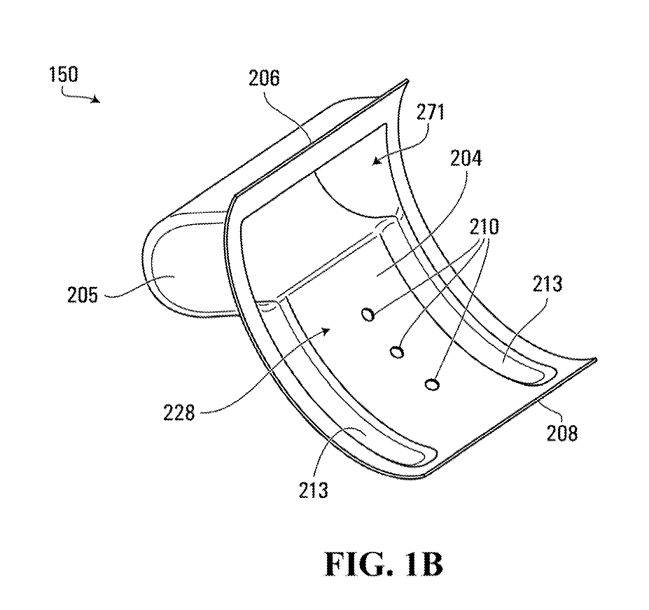

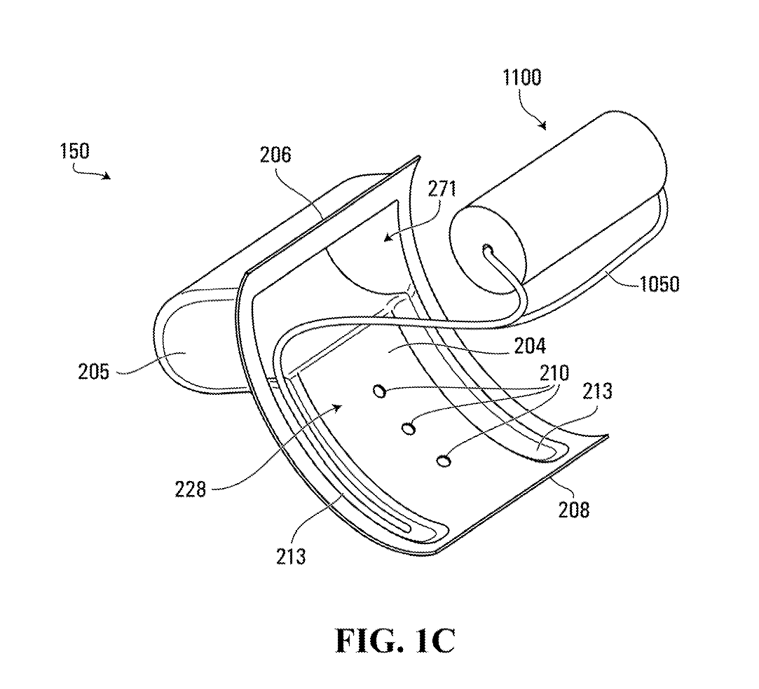

FIG. 1A shows a perspective view of a mounting bracket 150 in which may be mounted a motor capacitor (not shown in FIG. 1A) in accordance with a first specific embodiment.

As illustrated, the mounting bracket 150 includes a generally arcuate member 204 having a first extremity 206 and a second extremity 208. As will become more apparent later on, the mounting bracket 150 is configured to be used in a motor assembly having a motor body with a generally cylindrical outer surface that is complementary to the inner surface of the generally arcuate member 204 so that the arcuate member 204 can matingly engage a portion of the outer surface of the motor body. As will be shown later on in the description, the generally arcuate member 204 has a curvature that substantially corresponds to a curvature of the generally cylindrical outer surface of the motor body.

In the non-limiting embodiment shown in FIG. 1A, the arcuate member 204 has an extent corresponding to about a quarter (90°) of a circumference of the generally cylindrical outer surface of the motor body. It is however to be appreciated that in alternative embodiment, the arcuate member 204 may have an extent corresponding to any suitable portion of the circumference of a cylinder. It has been found that generally, mounting brackets having an arcuate member with an extent between about 70° and about 120° of the of a circumference of a cylinder provide a useful range of motion for a motor capacitor that would be mounted therein. It is however to be appreciated that narrower or broader extent can be contemplated in practical implementations.

As illustrated, a capacitor housing member 205 may be provided on an outer surface 227 of the arcuate member 204 of the mounting bracket for engaging and/or encasing a motor capacitor (shown as element 1100 in FIG. 1C). The motor capacitor may be an electrical capacitor or condenser for use with electric motors of the type known in the art. The capacitor housing member 205 may be configured in any suitable manner to allow interchanging or replacing a capacitor that would be engaged therein. In practical implementations, the capacitor housing member 205 may optionally include suitable electrical components and circuitry for engaging a motor capacitor and establishing the electrical connection with the motor components within a motor body. Such electrical components and circuitry, which are beyond the scope of the present disclosure, are known in the art to which this invention pertains and will therefore not be described in further detail here.

In the specific example shown in FIG. 1A, the capacitor housing member 205 is positioned proximate the first extremity 206 of the arcuate member 204; however it is to be appreciated that, in alternative embodiments, the capacitor housing member 205 may be positioned in any suitable location along the outer surface 227 of the arcuate member 204 between the first extremity 206 and the second extremity 208. The capacitor housing member 205 may further provided one or more wire positioning members 212. In the non-limiting example depicted, two wire positioning members 212 are provided each running longitudinally along a respective edge of the arcuate member 204; however, it is to be appreciated that such an example is not indented to be limiting, as the number and positions of the wire positioning members 212 may vary in different implementations. As it will become more apparent later on, the one or more wire positioning members 212 may house a portion of the electrical wiring connected to a capacitor that would be housed in the capacitor housing member 205.

The mounting bracket 150 may also include a set of apertures 210 formed along the generally arcuate member 204 and configured for engaging mechanical fasteners in order to at least partially secure the mounting bracket 150 to a motor body. In the specific implementation depicted in FIG. 1A, the set of apertures 210 includes three apertures (a first aperture 210ₐ₁, a second aperture 210ₐ₂ and a third aperture 210ₐ₃) formed along the generally arcuate member 204. The apertures 210ₐ₁₋ₐ₃ may be positioned between the capacitor housing member 205 and the second extremity 208 of the arcuate member and may be spaced at various intervals along the arcuate member 204 of the mounting bracket 150 in dependence on the specific angles the mounting bracket is designed to allow the capacitor housing member 205 to acquire when the bracket is mounted to a motor body. Although the mounting bracket 150 depicted in FIG. 1A has been shown as including three (3) regularly spaced apertures 210ₐ₁₋₃, it is to be appreciated that many suitable variants are possible. For instance, although the three apertures 210 are illustrated as being spaced at generally regular intervals and as being generally circular in shape, in alternative implementations the apertures 210 may be positioned at irregular intervals (i.e., any distance or any position) and/or the shape of the apertures 210 may be of any suitable shape, such as for example but without being limited to, oval, elliptical, rectangular or any suitable combination of shapes, such as for example a rectangular slot with curved corners. Moreover, while the embodiment depicted in FIG. 1A shows three apertures, it is to be appreciated that any suitable number of apertures may be formed along the generally arcuate member 204 in alternate embodiments.

FIG. 1B shows a perspective view of an inner surface 228 of the mounting bracket 150 of FIG. 1A in accordance with a non-limiting example of implementation. As illustrated, the mounting bracket 150 includes an aperture 271 generally aligned with the capacitor housing member 205 for allowing a capacitor to be inserted and housed in the capacitor housing 205. On the inner surface of the arcuate member 204, the one or more wire positioning members 212 form one or more complementary grooves or channels 213 for accommodating wires connected to a capacitor that would be housed in the capacitor housing member 205. The capacitor housing member 205 and/or the complementary grooves 213 of the wire positioning members 212 may allow electrical wiring to be placed therein for establishing an electrical connection between a motor capacitor engaged in the capacitor housing member 205 and electrical components of a motor in a motor housing to which the mounting bracket is to be attached.

FIG. 1C shows the perspective view of the inner surface of the mounting bracket 150 shown in FIG. 1B in which a capacitor 1100 is being been positioned in accordance with a non-limiting example of implementation. As depicted, electrical wiring 1050 connected to the capacitor 1100 can engage one of the complementary grooves 213 defined in the inner surface of the arcuate member 204.

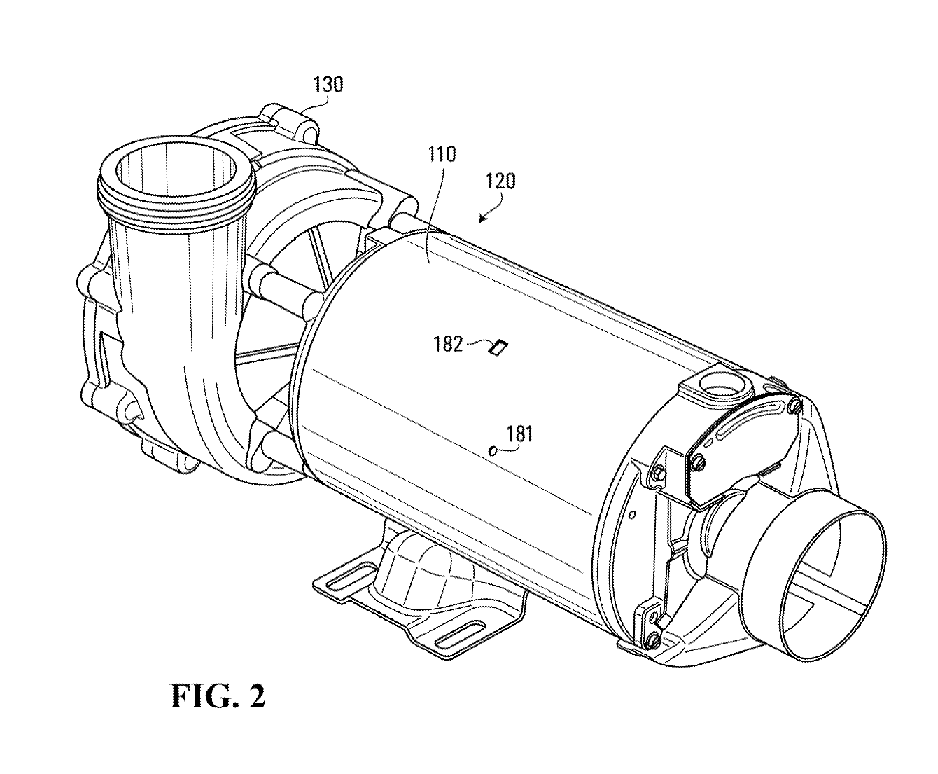

FIG. 2 shows a motor body 120 to which the mounting bracket 150 shown in FIGS. 1A and 1B may be mounted in accordance with a non-limiting example of implementation. It is to be appreciated that while the expression motor body 120 has been used in the present document, it is intended to be used interchangeably with motor shell and/or motor housing. As illustrated, a portion of the motor body 120 defines a generally cylindrical outer surface 110. The motor body 120 of the motor assembly 100 has an inner chamber for housing operational components of a motor (not shown in the figures). For example, the operational components may include a rotor which is rotatable about an axis and a stator which is spaced radially from the rotor. It is within the common general knowledge of the person skilled in the art that electric motors are designed so that electric current through the stator and rotor will generate opposed magnetic fields. Rotation of the motor shaft occurs as these magnetic fields attempt to align. More specifically, windings (e.g., wires laid in coils) may be present on either the stator and/or rotor, which form magnetic poles when energized with current. It is appreciated that, while such functional aspects are beyond the scope of the present description, they are within the reach of a person skilled in the art and thus will not be described in further detail here. It is also to be appreciated that other configurations of the operational components of the electric motor assembly 100 may be possible, and that the invention is not limited to the configuration of the operational components of the electric motor assembly 100 described herein.

In the non-limiting example shown, at least one aperture 181, complementary to any one of apertures 210ₐ₁₋₃ shown in FIG. 1A, is formed on the outer surface 110 of the motor body 120 and is configured for engaging a mechanical fastener, which may be in the form of a screw, passing through one of the apertures 210ₐ₁₋₃ shown in FIG. 1A in order to at least partially secure a mounting bracket 150 to the motor body 120. In a first specific embodiment, the complementary aperture in the motor body 120 may be in the form of a pre-drilled aperture. In a second specific embodiment, it may be required to drill or otherwise create a complementary aperture on the motor body 120 to accommodate the mechanical fastener.

Also in the non-limiting example shown in FIG. 2, a wiring or lead aperture 182, which will be generally aligned with one of the complementary grooves 213 of the mounting bracket 150 (shown in FIG. 1B), may be formed on the outer surface 110 of the motor body 120 for allowing electrical wiring to pass through the motor body 120 to establish a connection between a capacitor housed in the capacitor housing member 205 and electrical components of the motor in the motor body 120.

The motor body 120 shown in FIG. 2 is of a type suitable for use in connection with a water pump, such as those used in spa or pool systems. It is to be appreciated that such a motor has been shown for the purpose of illustration only and that a person skilled in the art should appreciated that a mounting bracket of the type suggest in FIGS. 1A and 1B can also be contemplated for other types of motors.

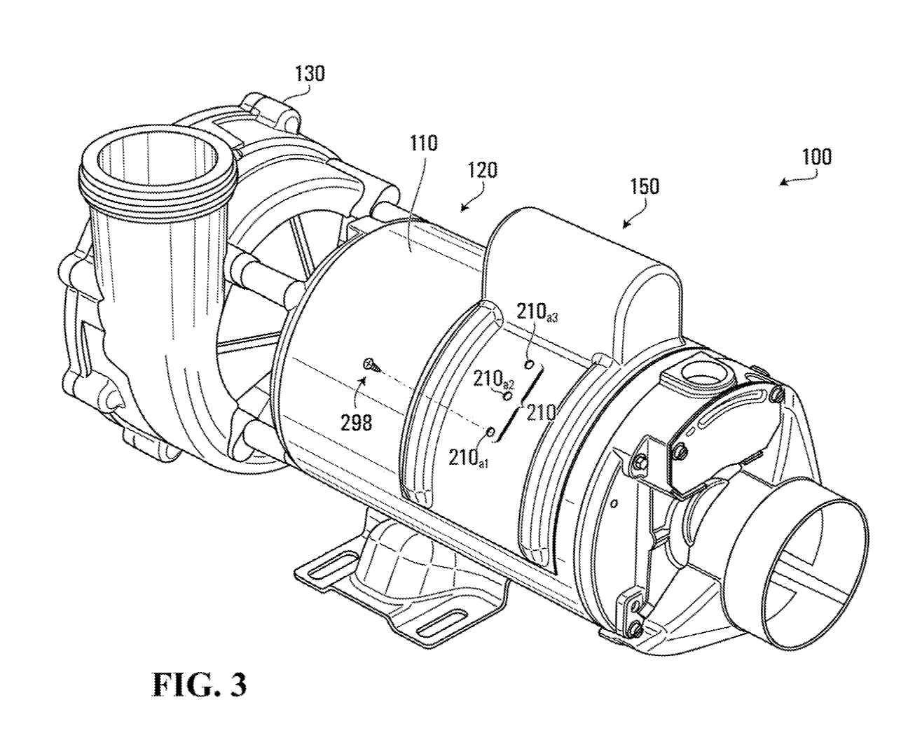

FIG. 3 shows a perspective view of a motor assembly 100 including the motor body 120 shown in FIG. 2 and the mounting bracket 150 shown in FIGS. 1A and 1B, wherein the mounting bracket 150 engages the motor body 120 in a first (forward) orientation and at a first angle. As it will become more apparent later, by rotating the mounting bracket 150 about the generally cylindrical outer surface of the motor body 120 and aligning a specific aperture in the set of apertures 210 with the complementary aperture 181 defined on the outer surface 110 of the motor body 120, the capacitor housing 205 may be positioned at different angles along a circumference of the motor body 120.

In the example illustrated, the mounting bracket 150 may be fastened to the motor body 120 using at least one mechanical fastener 298 to secure the mounting bracket 150 in a desired position. More specifically, in some embodiments, the mounting bracket 150 is fastened to the motor body 120 by a fastener 298 that engages one of the at least two apertures 210 of the mounting bracket 150 and the complementary aperture 181 formed on the outer surface 110 of the motor body 120. In the non-limiting embodiment depicted in FIG. 3, the mechanical fastener 298 includes a screw. It is to be appreciated that other suitable form of mechanical fasteners, such as for example clips, straps, anchors, bolts, rivets and the like, may be used in alternative implementations.

In addition, electrical wiring is connected between the capacitor housed in the capacitor housing member 205 and electrical components of the motor in the motor body 120 through the aperture 271 and/or one of the complementary grooves 213 of the wire positioning members 212 of the mounting bracket 150 (shown in FIGS. 1B and 1C) and the wiring or lead aperture 182 of the motor body (shown in FIG. 2).

Such a configuration may allow for a motor capacitor engaging in the capacitor housing member 205 of mounting bracket 150 to be electrically connected through suitable electrical wiring to circuitry in the motor housing 120. For instance, in some embodiments, the capacitor 1100 (shown in FIG. 1C) includes a pair of attached terminals which are connected by a pair of leads to the electric motor (e.g., the input power terminals for the motor) by passing through the aperture 271 of the capacitor housing member 205 and/or one of the complementary grooves 213 of the wire positioning members 212. It is to be appreciated that the aperture 271 of the mounting bracket 150 and the wiring or lead aperture 182 of the motor body need not align with one another provided an electrical connection can be established. For example, the wiring from the capacitor 1100 housed in the capacitor housing member 205 may be travel inside the complementary grooves 213 of the wire positioning members 212, when the aperture 271 of the mounting bracket 150 and the wiring or lead aperture 182 of the motor body are not aligned.

Such a configuration may allow for the mounting bracket 150 to be positioned flush and rotatable about the outer surface 110 of the motor body 120 while allowing for the electrical connection between the capacitor housed in the capacitor housing member 250 and the operational components in the motor body 120 to be maintained. It is also appreciated that such a configuration may allow for the electrical components and wiring to be shielded from water, humidity or other undesirable contaminants that may interfere with the operational components of the motor.

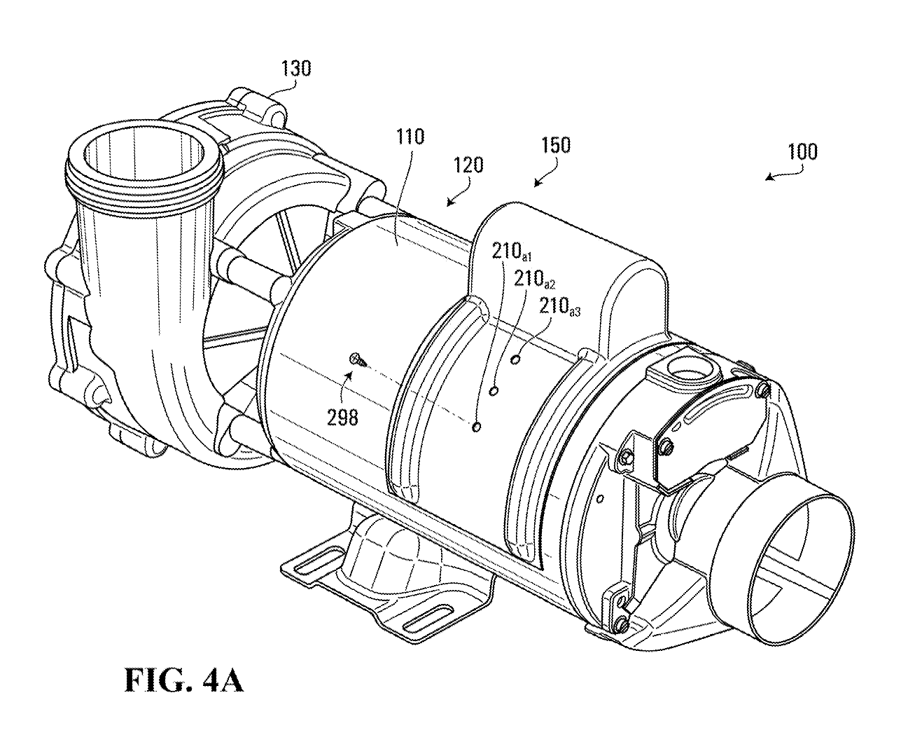

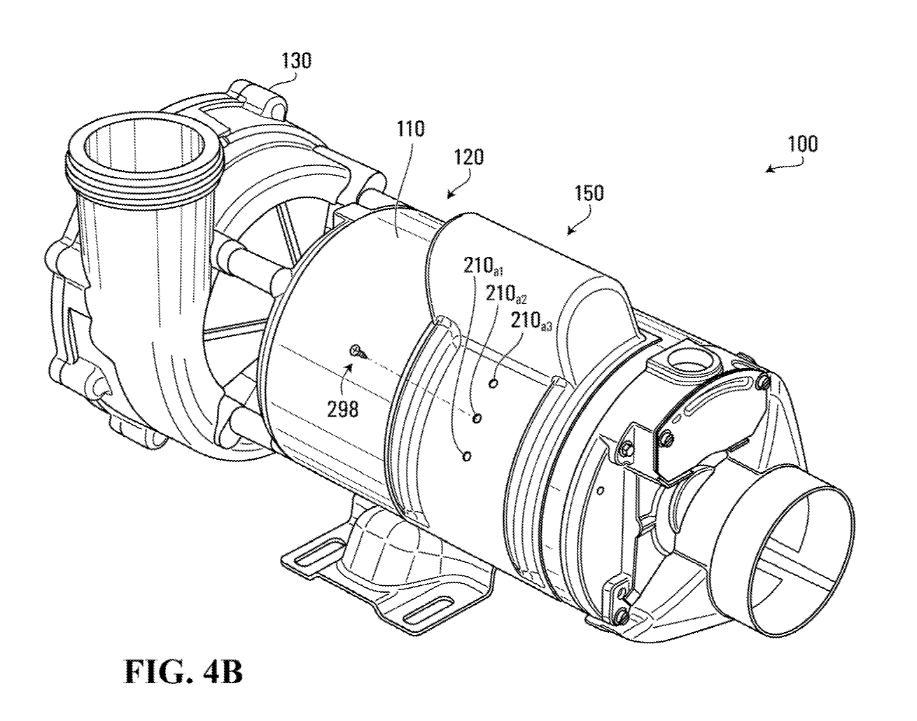

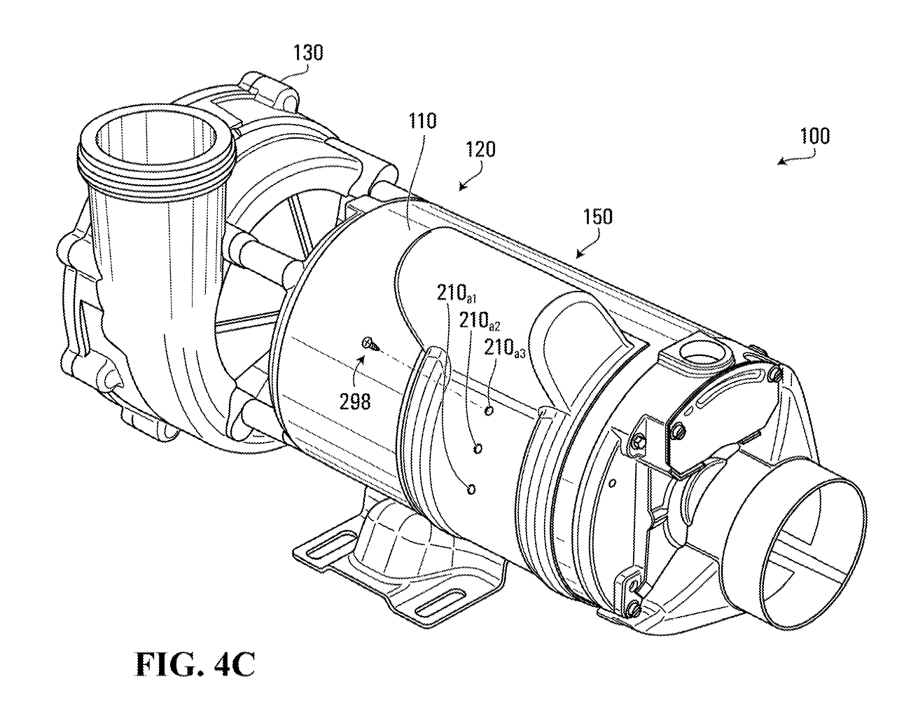

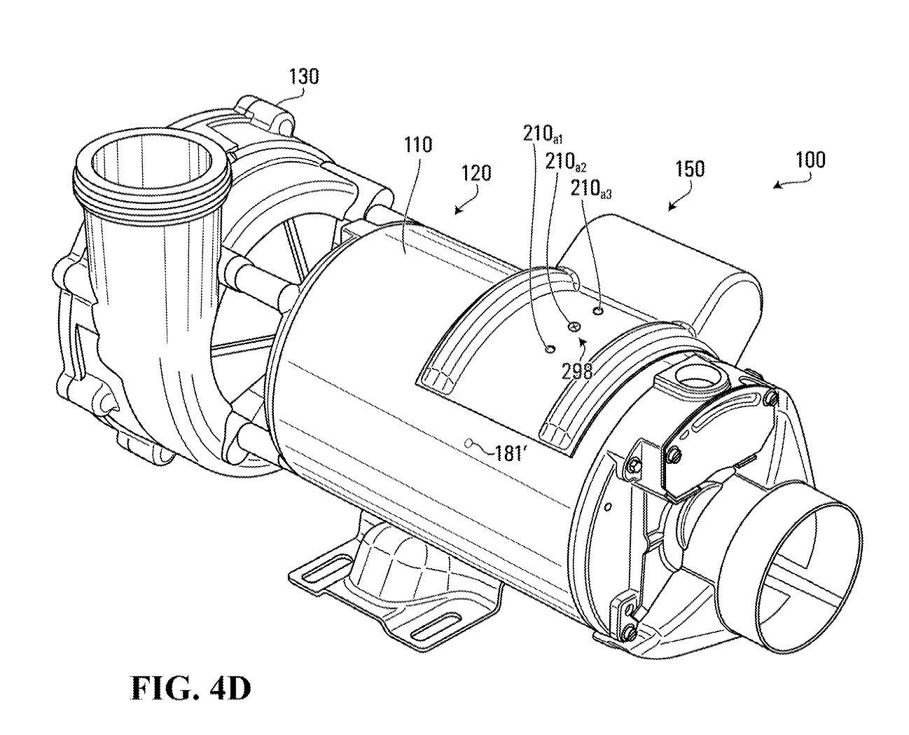

FIGS. 4A to 4D show perspective views of the motor assembly 100 of FIG. 3 showing the mounting bracket 150 engaging the motor body 120 in a first (forward) orientation at different angles in accordance with a specific example of implementation.

As illustrated in FIG. 4A, to position the capacitor housing member 205 at a first specific angle along the circumference of the motor body 120, the mounting bracket 150 can be rotated about the generally cylindrical outer surface 110 of the motor body 120 in order to align the first aperture 210ₐ₁ of the mounting bracket 150 with the complementary aperture 181 defined on the outer surface 110 of the motor body 120. Once the first aperture 210ₐ₁ and the complementary aperture 181 are aligned, one or more mechanical fasteners (which in the illustrated embodiment include a screw) can be used to secure the mounting bracket 150 to the motor body 120 to prevent further rotation. For instance, in FIG. 4A, to secure the mounting bracket 150 to the generally cylindrical outer surface 110 of the motor body 120 in a first position, the fastener 298 may engage the first aperture 210ₐ₁ and aperture 181 in the motor body 120.

As illustrated in FIG. 4B, to position the capacitor housing member 205 at a second specific angle along the circumference of the motor body 120, the mounting bracket 150 can be rotated about the generally cylindrical outer surface 110 of the motor body 120 in order to align the second aperture 210ₐ₂ of the mounting bracket 150 with the complementary aperture 181 defined on the outer surface 110 of the motor body 120. Once the second aperture 210ₐ₂ and the complementary aperture 181 are aligned, one or more mechanical fasteners (which in the illustrated embodiment include a screw 298) can be used to secure the mounting bracket 150 to the motor body 120 to prevent further rotation. For instance, in FIG. 4B, to secure the mounting bracket 150 to the generally cylindrical outer surface 110 of the motor body 120 in a second position, the fastener 298 may engage the second aperture 210ₐ₂ and aperture 181 in the motor body 120.

As illustrated in FIG. 4C, to position the capacitor housing member 205 at a third specific angle along the circumference of the motor body 120, the mounting bracket 150 can be rotated about the generally cylindrical outer surface 110 of the motor body 120 in order to align the third aperture 210ₐ₃ of the mounting bracket 150 with the complementary aperture 181 defined on the outer surface 110 of the motor body 120. Once the second aperture 210ₐ₃ and the complementary aperture 181 are aligned, one or more mechanical fasteners (which in the illustrated embodiment include a screw 298) can be used to secure the mounting bracket 150 to the motor body 120 to prevent further rotation. For instance, in FIG. 4C, to secure the mounting bracket 150 to the generally cylindrical outer surface 110 of the motor body 120 in a third position, the fastener 298 may engage the third aperture 210ₐ₃ and aperture 181 in the motor body 120.

As will become apparent to the reader, the relative positioning of the apertures in the set of apertures 210 on the mounting bracket 150 provides for respective angles to be achieved for positioning of the capacitor housing member 205 along the circumference of the motor body 120 by rotating the mounting bracket about the generally cylindrical outer surface of the motor body.

When the curvature of the arcuate member 204 substantially corresponds to the curvature of the generally cylindrical outer surface 110 of the motor body 120, the mounting bracket 150 can rotate about the outer surface 110 while still being displaceably engaged with the generally cylindrical shaped outer surface 110. In other words, the mounting bracket 150 can be rotatably displaced about the motor body 120 to acquire different radial positions on the generally cylindrical outer surface 110 of the motor body 120.

In FIG. 4A, the mounting bracket 150 is in a first position and the capacitor housing member 205 is at a first specific angle along the circumference of the motor body 120. The mounting bracket 150 can then be rotated (counter clock wise in the figure) to a second position shown in FIG. 4B in which the capacitor housing member 205 is at a second specific angle along the circumference of the motor body 120. The mounting bracket 150 can then be rotated (counter clock wise in the figure) to a third position shown in FIG. 4C in which the capacitor housing member 205 is at a third specific angle along the circumference of the motor body 120.

In the example illustrated, as the apertures 210ₐ₁₋₃ are spaced apart by a fixed distance, when the apertures 210 are aligned with the aperture 181 defined on the outer surface 110 of the motor body 120 the angular distance between each position (e.g., the first position, the second position and the third position) may be measurable in degrees and, as such, the positioning of the apertures 210 may allow for the capacitor housing member 205 to be positioned at specific angles by rotating the mounting bracket 150 radially about the generally cylindrical outer surface 110. By way of a specific and non-limiting example, the rotation between the first position, the second position and the third position may be approximately 15 degrees between each position as defined by the spacing of the apertures 210. It is to be understood that the positioning of the apertures 210 on the mounting bracket 150 may be defined for any suitable range of rotation in degrees about the generally cylindrical shaped outer surface 110.

It is appreciated that, for all the three positions of the capacitor housing member 205 shown in FIGS. 4A, 4B and 4C, the proposed motor assembly may allow using a single aperture 181 on the outer surface 110 of the motor body 120, thereby managing the structural integrity of the motor body 120 by limiting the number of apertures required thereon.

A fourth position for the capacitor housing member 205 along the circumference of the motor body 120 is illustrated in FIG. 4D. This position may be achieved by rotating the mounting bracket 150 clock wise about the generally cylindrical outer surface 110 from the position shown in FIG. 4A.

In the fourth position shown in FIG. 4D, the mounting bracket 150 may be fastened to the generally cylindrical outer surface 110 of the motor body 120 by a mechanical fastener 298 that engages at least one of the apertures 210 of the mounting bracket 150 (here shown as aperture 210ₐ₂) and a complementary aperture formed in the motor body 120. In the specific non-limiting example shown, a new complementary aperture (not shown in the figure) is drilled on the outer surface of the motor body 120 at a location aligned with the aperture 210ₐ₂ to accommodate the mechanical fastener 298. Optionally the (pre-drilled) aperture 181, which is shown as aperture 181′ in FIG. 4D, can be filled in using a suitable filling material or compound in order to reduce the likelihood of damage to the motor body, for example by reducing the likelihood of water or moisture entering the motor body 120 through the aperture 181′.

Although in FIGS. 4A to 4D four different positions for the mounting bracket 150 are illustrated, the person of skill in the art will appreciate that in alternative embodiments any suitable number of positions may be contemplated by providing a mounting bracket 150 with a suitable number of apertures positioned along the arcuate member 204 and/or by allowing a complementary aperture to be drilled as needed on the motor body 120.

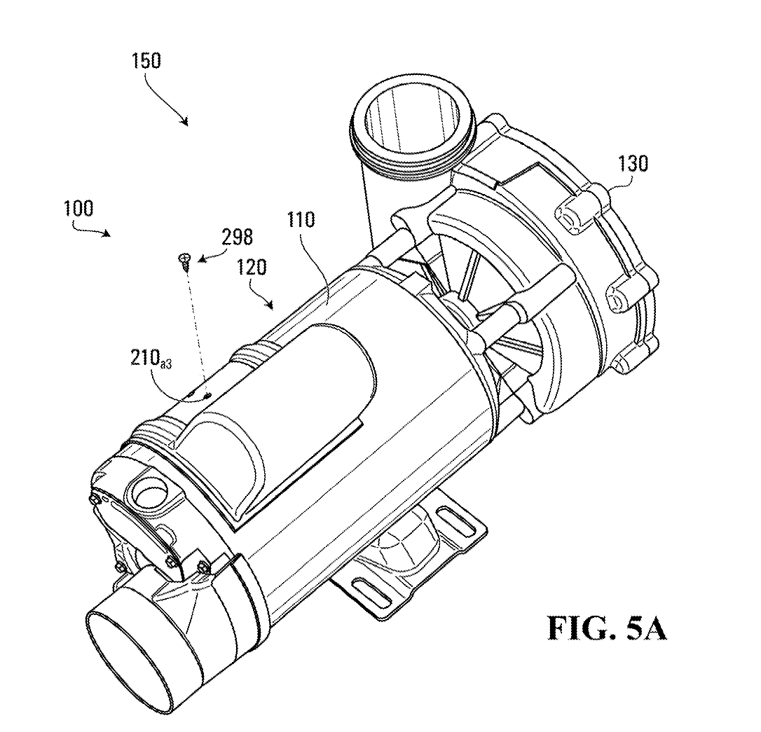

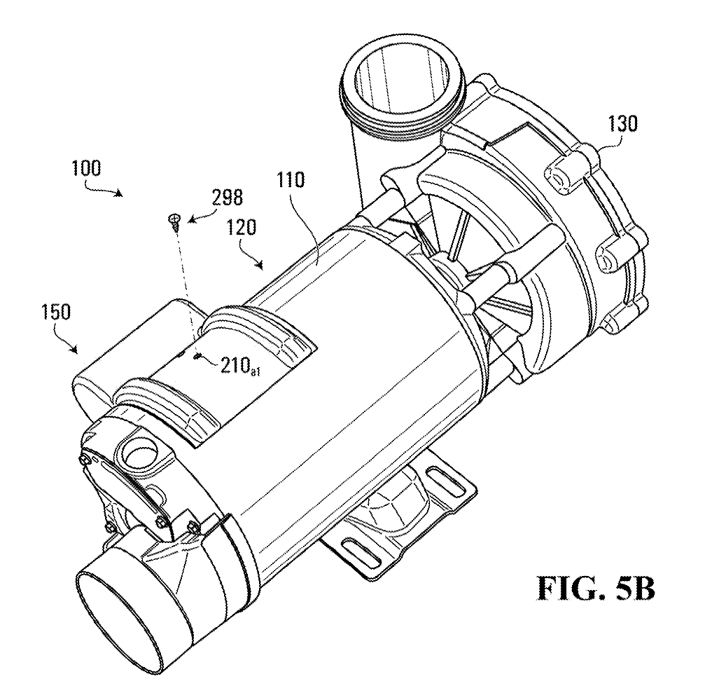

Optionally the mounting bracket 150, in addition to being rotatable about the generally cylindrical outer surface 110 of the motor body 120 may also be configured to be reversible in relation to the outer surface 110 of the generally cylindrical motor body 120. This aspect may be better understood with reference to FIGS. 5A and 5B.

More specifically, FIGS. 5A and 5B show perspective views of the motor assembly 100 with the mounting bracket of FIG. 1A engaging the motor body 120 shown in FIG. 2 in a first (forward) orientation (FIG. 5A) and in a second (reverse) orientation (FIG. 5B). In this example, the generally arcuate member 204 of the mounting bracket displaceably engages the generally cylindrical outer surface 110 of the motor body 120. As the curvature of the arcuate member 204 in the example depicted substantially matches the generally cylindrical outer surface 110 of the motor body 120, the mounting bracket 150 is able to be reversed in position on the outer surface 110. As illustrated in FIG. 5A, the mounting bracket 150 in a first (forward) orientation which may be reversed from its position where the capacitor housing member 205 is on one side of the motor body 120 to a second (reverse) orientation on the other side of the motor housing 120, as illustrated in FIG. 5B.

As illustrated in FIG. 5A, to position the capacitor housing member 205 at a specific angle along the circumference of the motor body 120, the mounting bracket 150 can be rotated about the generally cylindrical outer surface 110 of the motor body 120 in order to align the third aperture 210ₐ₃ of the mounting bracket 150 with the complementary aperture 181 defined on the outer surface 110 of the motor body 120. Once the third aperture 210ₐ₃ and the complementary aperture 181 are aligned, one or more mechanical fasteners (which in the illustrated embodiment include a screw 298) can be used to secure the mounting bracket 150 to the motor body 120 to prevent further rotation. For instance, in FIG. 5A, to secure the mounting bracket 150 to the generally cylindrical outer surface 110 of the motor body 120, the fastener 298 may engage the third aperture 2100 and aperture 181 in the motor body 120.

As illustrated in FIG. 5B, to position the capacitor housing member 205 at a specific angle along the circumference of the motor body 120, the mounting bracket 150 can be placed in the second (reverse) orientation and can be rotated about the generally cylindrical outer surface 110 of the motor body 120 in order to align the first aperture 210ₐ₁ of the mounting bracket 150 with the complementary aperture 181 defined on the outer surface 110 of the motor body 120. Once the first aperture 210ₐ₁ and the complementary aperture 181 are aligned, one or more mechanical fasteners (which in the illustrated embodiment include a screw 298) can be used to secure the mounting bracket 150 to the motor body 120 to prevent further rotation. For instance, in FIG. 5B, to secure the mounting bracket 150 to the generally cylindrical outer surface 110 of the motor body 120, the fastener 298 may engage the first aperture 210ₐ₁ and aperture 181 in the motor body 120.

It is to be appreciated by those skilled in the art that such a configuration may allow for the positioning of the capacitor housing 204 at additional locations by reversing the orientation from the first (forward) orientation of the mounting bracket 150 to the second (reverse) orientation about the generally cylindrical outer surface 110 of the motor body 120, while still using a single aperture 181 on the generally cylindrical outer surface 110 of the motor body 120. As such, this may allow for a single aperture 181 on the generally cylindrical outer surface 110 of the motor body 120 to provide for multiple positions of the capacitor while managing the structural integrity of the motor body 120 by limiting the number of aperture formed on the motor body 120.

In the non-limiting example depicted in FIGS. 4A-4D, 5A and 5B, the mounting bracket 150 includes two wire positioning members 212 each running longitudinally along a respective edge of the arcuate member 204, where each of the wire positioning members 212 forms a respective complementary grooves or channels 213 (shown in FIG. 1B). Such a configuration may allow for a first one of the complementary grooves 213 to be aligned with the wiring or lead aperture 182 formed on the motor body (shown in FIG. 2) when the mounting bracket 150 is in a first (forward) orientation (shown in FIG. 5A) and for a second one of the complementary grooves 213 to be aligned with the wiring or lead aperture 182 when the mounting bracket 150 is in the second (reverse) orientation (shown in FIG. 5B).

### Variants

Many modifications to the specific embodiments of the mounting bracket 150 for a motor capacitor are possible and will become apparent to the person skilled in the art in view of the present description.

For example, while in the embodiments of the mounting bracket 150 described with reference to FIGS. 1A and 1B a capacitor housing member 205 that can substantially enclose a capacitor has been described, in alternative embodiments the capacitor housing member 205 may only partially enclose the capacitor and/or may be replaced with one or more capacitor fastening members for engaging a capacitor without however enclosing the capacitor. It is noted however that in some implementations, for example in cases in which the motor assembly in intended to be used in an environment in which there may be moisture or water, safety considerations may require a capacitor housing member that encloses the capacitor.

In other variants, the size and/or configuration of the generally arcuate member 204 may be altered.

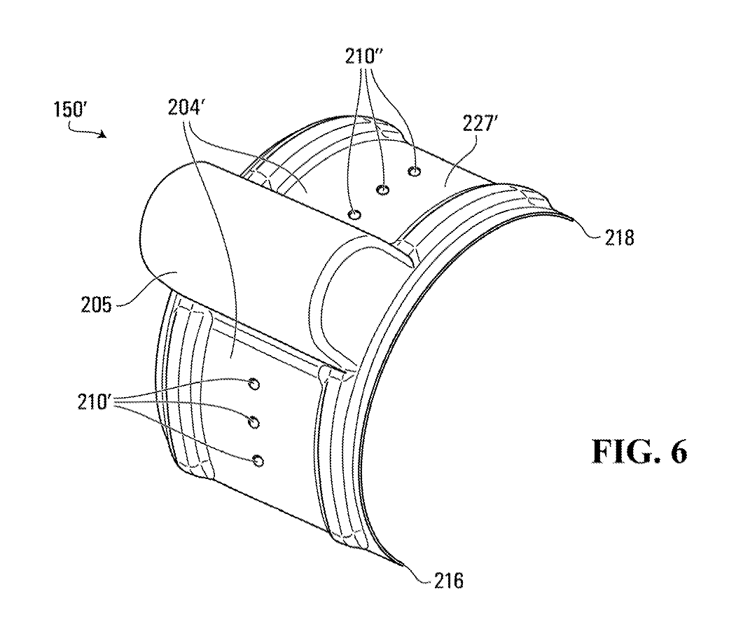

FIG. 6 shows a perspective view of a mounting bracket 150′ for a motor capacitor in accordance with a second embodiment. As shown, the mounting bracket 150′ has a first extremity 216 and a second extremity 218 and is configured to be used in a motor assembly having a motor body with a generally cylindrical outer surface of the type depicted in FIG. 2. The generally arcuate member 204′ has a curvature that substantially corresponds to a curvature of the generally cylindrical outer surface of the motor body 120 (shown in FIG. 2) so that the arcuate member 204′ can matingly engage a portion of the outer surface of the motor body.

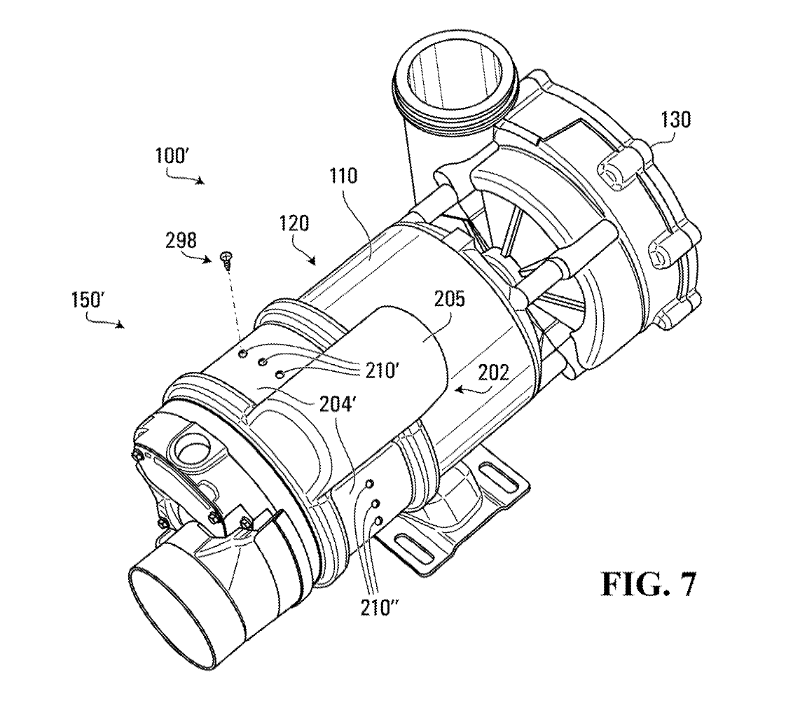

In the non-limiting embodiment shown in FIG. 6, the arcuate member 204′ has an extent corresponding to about two thirds (120°) of a circumference of the generally cylindrical outer surface of the motor body 120. It is however to be appreciated that, in alternative embodiments, the arcuate member 204′ may have an extent corresponding to any suitable portion of the circumference of a cylinder. It has been found that generally, mounting brackets of the type shown in FIG. 7 having an arcuate member with an extent between about 90° and about 180° of the circumference of a cylinder provide a useful range of motion for a motor capacitor that would be mounted therein. It is however to be appreciated that a narrower or broader extent can be contemplated in some practical implementations.

As illustrated, a capacitor housing member 205 may be provided on an outer surface 227′ of the arcuate member 204′ of the mounting bracket 150′ for engaging and/or encasing a motor capacitor. In the specific example shown in FIG. 6, the capacitor housing member 205′ is positioned between the first extremity 216 and the second extremity 218. The mounting bracket 150′ may also include sets of apertures 210′ 210″ formed along the generally arcuate member 204′ configured for engaging mechanical fasteners in order to at least partially secure the mounting bracket 150′ to a motor body. In practical implementations, a first set of apertures 210′ may be formed on the arcuate member 204′ on a first side of the capacitor housing member 205′ and a second set of apertures 210″ may be formed on the arcuate member 204′ on a second side of the capacitor housing member 205′. The apertures in the sets 210′ 210″ may be spaced at various intervals along the arcuate member 204′ of the mounting bracket 150′ in dependence on the specific angles the mounting bracket is designed to allow the capacitor housing 205′ to acquire when the bracket is mounted to a motor body. Although the mounting bracket 150′ depicted in FIG. 6 has been shown as including six (6) regularly spaced circular apertures, it is to be appreciated that many suitable variants are possible. For instance, although the three apertures are illustrated in the set 210′ on one side of the capacitor housing member 205′ are spaced at a generally regular interval and are shown as being generally circular in shape, in alternative implementations the apertures in the set 210′ may be positioned at an irregular interval (i.e., any distance or any position). Alternatively, or in addition, the apertures may be of any suitable shape, such as for example, without being limited to oval, circular, elliptical, rectangular or any suitable combination of shapes, such as for example a rectangular slot with curved corners. Moreover, while the embodiment depicted in FIG. 6 shows three apertures in each set 210′ and 210″, it is to be appreciated that any suitable number of apertures may be formed in each set of apertures along the generally arcuate member 204′.

FIG. 7 shows a perspective view of a motor assembly 100′ including the motor body 120 shown in FIG. 2 and the mounting bracket 150′ shown in FIG. 6, wherein the mounting bracket 150′ engages the motor body 120 at a first angle. As it will become more apparent later, by rotating the mounting bracket 150′ about the generally cylindrical outer surface of the motor body 120 and aligning a specific aperture in the sets of apertures 210′ and 210″ with the complementary aperture 181 defined on the outer surface 110 of the motor body 120 (shown in FIG. 2), the capacitor housing member 205 may be positioned at different angles along a circumference of the motor body 120.

Optionally, as in the example illustrated, the mounting bracket 150′ may be fastened to the motor body 120 using at least one mechanical fastener 298 to secure the mounting bracket 150′ in a desired position. More specifically, in some embodiments, the mounting bracket 150′ is fastened to the motor body 120 by a fastener 298, engaging one of the apertures of the mounting bracket 150′ and the complementary aperture 181 formed on the outer surface 110 of the motor body 120. In the non-limiting embodiment depicted in FIG. 7, the mechanical fastener 298 includes a screw. It is to be appreciated that other suitable form of mechanical fasteners may be used in alternative implementations. In addition, in alternative embodiments, the use of a mechanical fastener may be omitted and one may in some cases rely at least in part on the frictional and tensile forces between the inner surface of the mounting bracket 150′ and the outer surface of the motor body 120 in order to secure the mounting bracket 150′ in place.

In addition, in a manner analogous to that described with reference to FIG. 3, electrical wiring is used to connect the capacitor housed in the housing member 205 and electrical components of the motor in the motor body 120 by passing the wiring through one of the complementary grooves or channels 213 of the mounting bracket 150′ and the wiring or lead aperture 182 of the motor body (shown in FIG. 2).

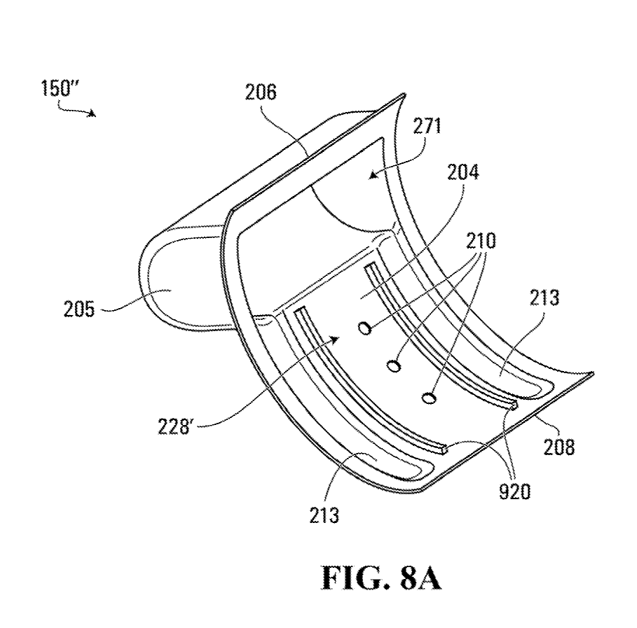

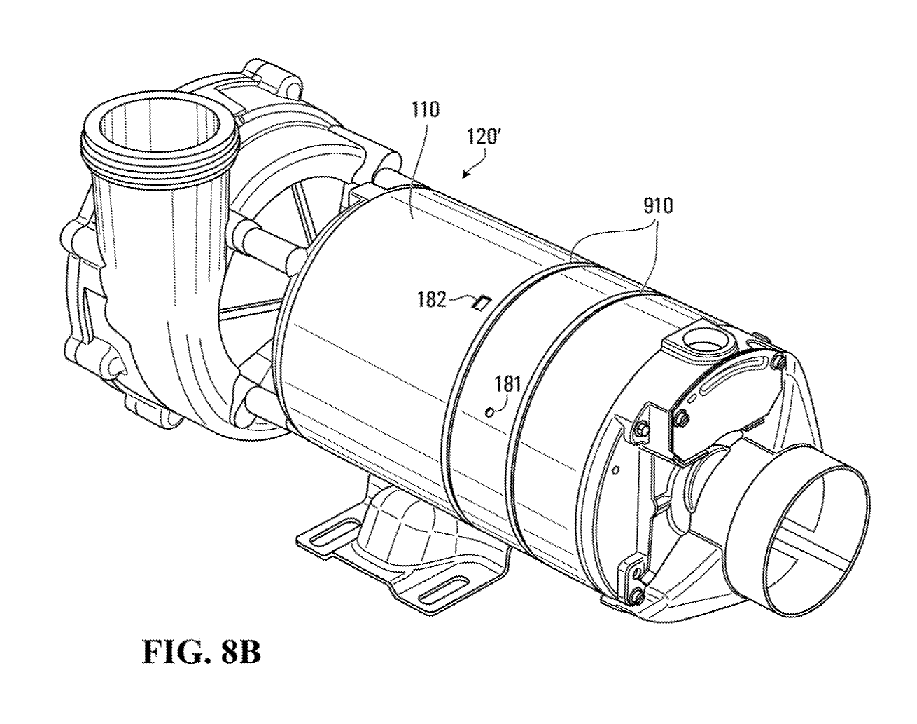

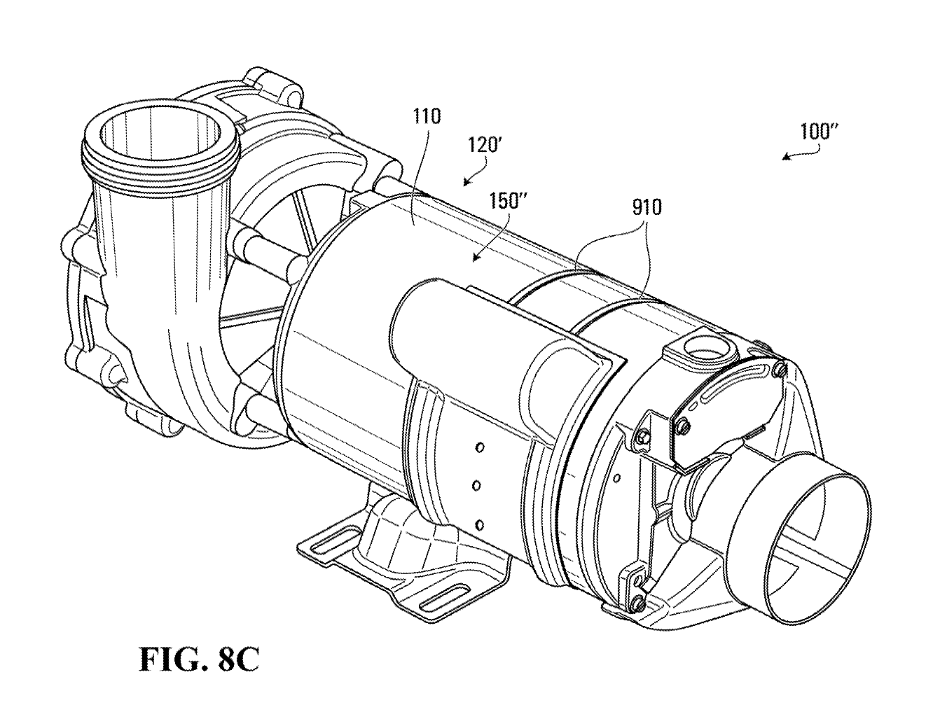

FIG. 8A shows a perspective view of an inner surface 228′ of a mounting bracket 150″ similar to the mounting bracket 150 shown in FIG. 1A in accordance with a first variant. As illustrated, the inner surface 228′, in addition to defining element similar to the elements described with reference to inner surface 228 (shown in FIG. 1B), defines guiding rails 920. As will become apparent below, the guiding rails 920 are for facilitating positioning and rotating the mounting bracket 150″ about a generally cylindrical outer surface of a motor body having complementary guiding rails defined there upon.

FIG. 8B shows a motor body 120′ to which the mounting bracket 150″ shown in FIG. 8A may be mounted in accordance with the present variant. As illustrated, motor body 120′, which is analogous to motor body 120 (shown in FIG. 2), has an outer surface on which are defined guiding rails 910 complementary to guiding rails 920 of mounting bracket 150″ (shown in FIG. 8A). The guiding rails 920 of the mounting bracket are configured for matingly engaging the corresponding guiding rails 910 defined on the generally cylindrical outer surface 110 of the motor body 120′. In the embodiment depicted in FIGS. 8A and 8B, the guiding rails 920 of mounting bracket 150″ are oriented longitudinally along each side of the inner surface 228′ of the generally arcuate member 204 and the corresponding guiding rails 910 defined on the generally cylindrical outer surface 110 of the motor body are oriented along at least a portion of the circumference of the motor body 120′. While two guiding rails are shown on each of the inner surface of the mounting bracket 150″ and outer surface of the motor body 120′, it is to be appreciated that alternative practical embodiments may include fewer or additional guiding rails.

FIG. 8C shows a perspective view of a motor assembly 100″ including the motor body 120′ shown in FIG. 8B and the mounting bracket 150″ shown in FIG. 8A, wherein the mounting bracket 150″ engages the motor body 120′ at a first angle. As illustrated in the figure, when the mounting bracket 150″ and the motor body 120′ are assembled, the guiding rails 920 defined on the inner surface of the mounting bracket 150″ and the guiding rails 910 defined on the outer surface of the motor body 120′ matingly engage one another. Such an assembly may facilitate in some cases the positioning of the mounting bracket 150″ relative to the motor body 120′ and may also facilitate rotation of the mounting bracket about the generally cylindrical outer surface of the motor body.

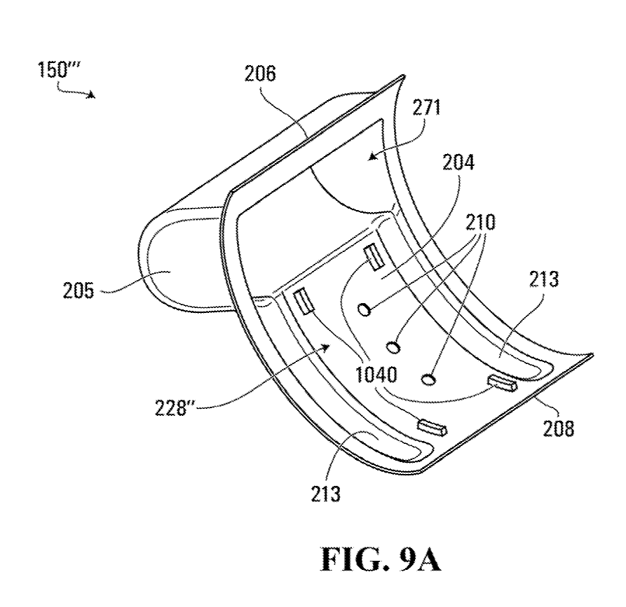

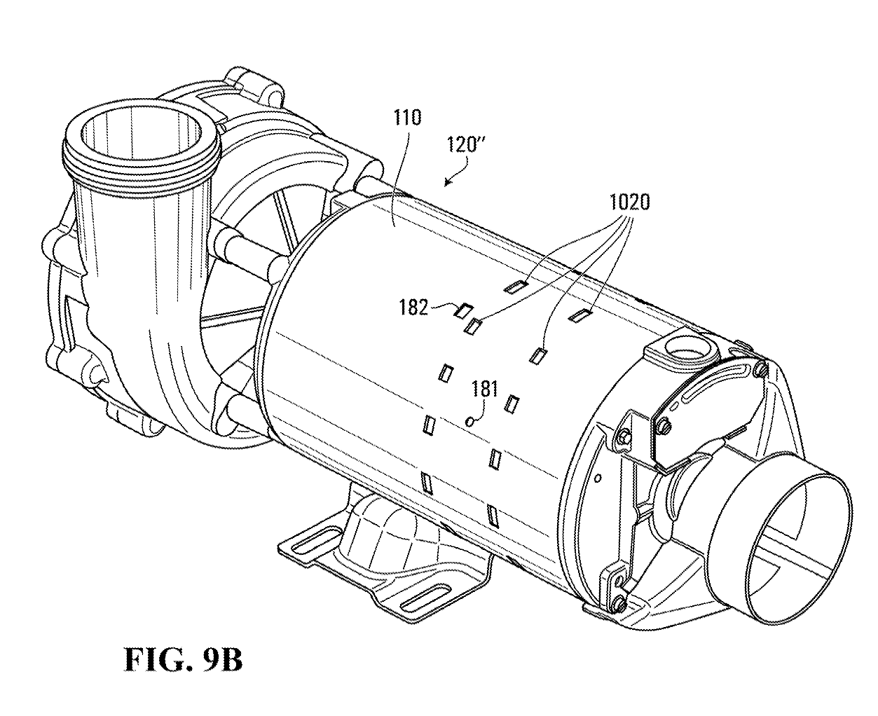

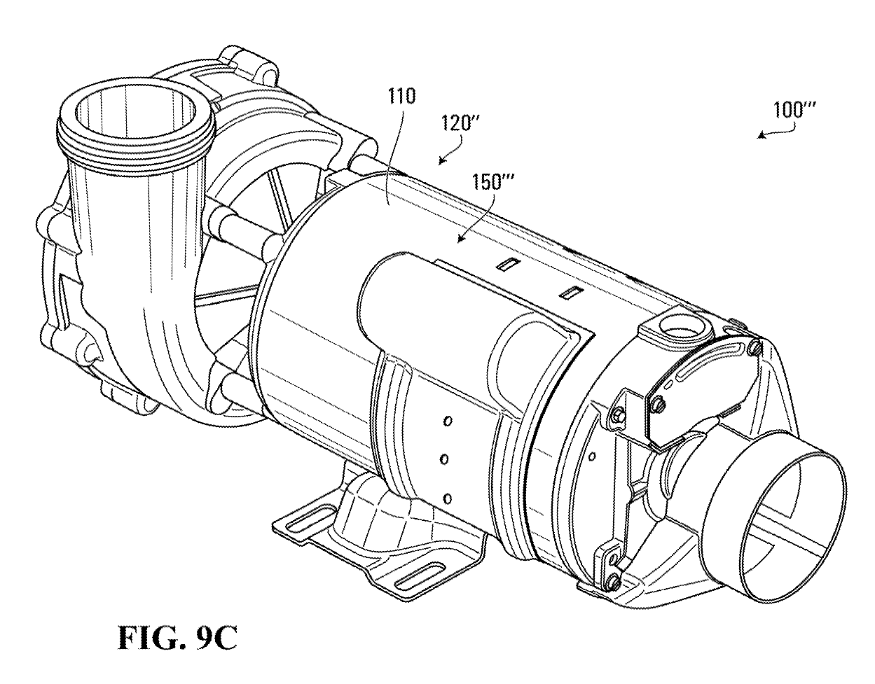

FIG. 9A shows a perspective view of an inner surface 228″ of a mounting bracket 150′″ similar to the mounting bracket 150 shown in FIG. 1A in accordance with a second variant. As illustrated, the inner surface 228″, in addition to defining element similar to the elements described with reference to inner surface 228 (shown in FIG. 1B), defines a set of positioning members 1040. As will become apparent below, the positioning members 1040 are for facilitating positioning the mounting bracket 150′″ at a specific angle about a generally cylindrical outer surface of a motor body having complementary positioning members defined there upon.

FIG. 9B shows a motor body 120″ to which the mounting bracket 150′″ shown in FIG. 9A may be mounted in accordance with this second variant. As illustrated, motor body 120″, which is analogous to motor body 120 (shown in FIG. 2), has an outer surface on which are defined positioning members 1020 complementary to positioning members 1040 of mounting bracket 150′″ (shown in FIG. 9A). The positioning members 1040 of the mounting bracket are configured for matingly engaging the corresponding positioning members 1020 defined on the generally cylindrical outer surface 110 of the motor body 120″. In the embodiment depicted in FIGS. 9A and 9B, the positioning members 1040 of mounting bracket 150′″ include a set of generally rectangular projections formed on the inner surface 228″ of the generally arcuate member 204 and the corresponding positioning members 1020 defined on the generally cylindrical outer surface 110 of the motor body are generally rectangular cavities or indentations corresponding to the projections defined on the inner surface of the mounting bracket 150′″ and located a different angles about the circumference of the motor body 120″ to facilitate the positioning of the mounting bracket in numerous angles about the generally cylindrical outer surface 110 of the motor body 120″.

FIG. 9C shows a perspective view of a motor assembly 100′″ including the motor body 120″ shown in FIG. 9B and the mounting bracket 150′″ shown in FIG. 9A, wherein the mounting bracket 150′″ engages the motor body 120″ at a first angle. As illustrated in the figure, when the mounting bracket 150′″ and the motor body 120″ are assembled, the positioning members 1040 defined on the inner surface of the mounting bracket 150′″ and the positioning members 1020 defined on the outer surface of the motor body 120″ matingly engage on another. Such an assembly may facilitate in some cases the positioning of the mounting bracket 150′″ relative to the motor body 120″ and may also facilitate securing the mounting bracket at a specific angle about the generally cylindrical outer surface of the motor body.

It is to be appreciated that the shape and dimensions of the positioning members 1020 and 1040 shown in FIGS. 9A and 9B is but one possible example. For example, in some embodiments, one or more positioning members formed on the inner surface of the mounting bracket may include one or more elongated members extending generally transversely across the inner surface 228″ of the mounting bracket and, similarly, one or more corresponding positioning members may be formed on the outer surface of the motor body and may be oriented transversely to the circumference of the motor body to facilitate positioning of the mounting bracket to the motor body. Many variations are possible and may become apparent to persons skilled in the art in light of the present description.

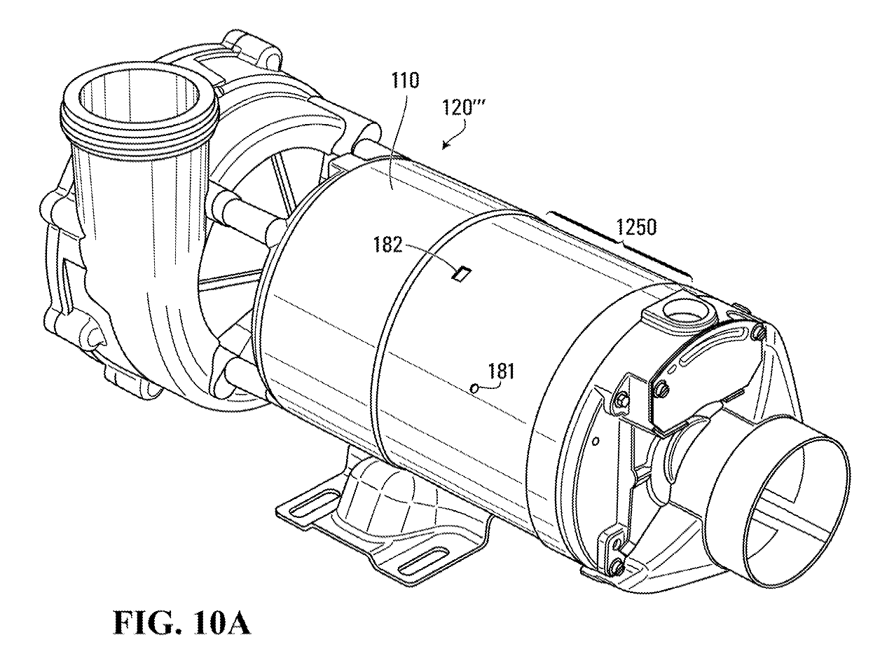

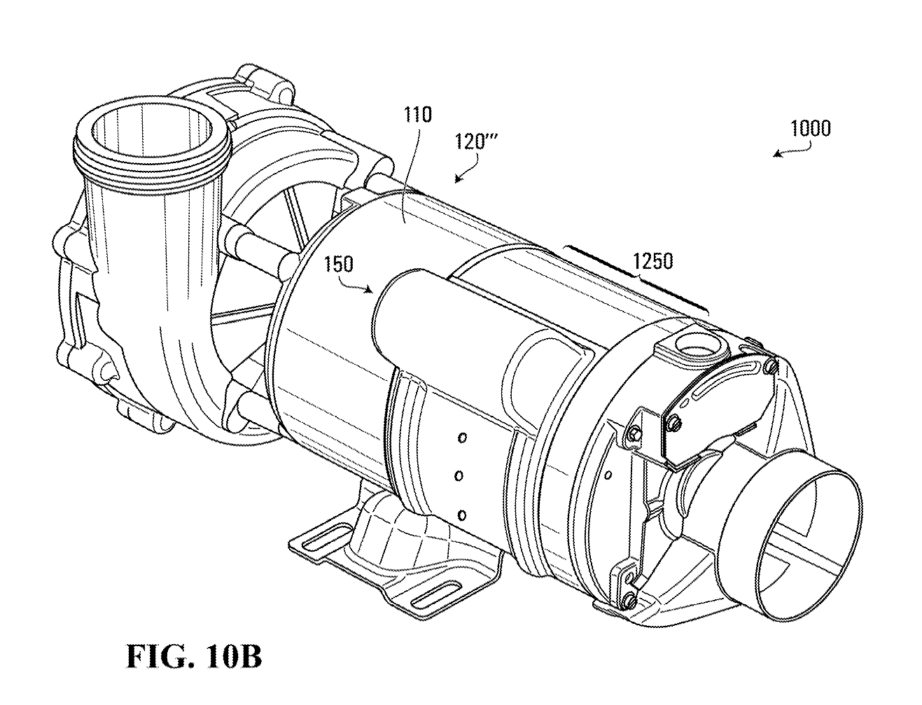

FIG. 10A shows a motor body 120′″ to which the mounting bracket 150 of the type shown in FIG. 1A may be mounted in accordance with another variant. As illustrated, motor body 120′″, which is analogous to motor body 120 (shown in FIG. 2), has an outer surface on which is defined a guiding rail 1250 forming passageway for the generally arcuate member 204 of the mounting bracket 150. The arcuate member 204 of the mounting bracket is configured for matingly engaging the guiding rail 1250 defined on the generally cylindrical outer surface 110 of the motor body 120′″.

FIG. 10B shows a perspective view of a motor assembly 1000 including the motor body 120′″ shown in FIG. 10A and the mounting bracket 150 shown in FIG. 1A. As illustrated in the figure, when the mounting bracket 150 and the motor body 120′″ are assembled, the arcuate member 204 of the mounting bracket 150 and the guiding rail 1250 defined on the outer surface of the motor body 120′″ matingly engage one another. Such an assembly may facilitate in some cases the positioning of the mounting bracket 150 relative to the motor body 120′″ and may also facilitate rotation of the mounting bracket about the generally cylindrical outer surface of the motor body.

Yet other variants of the mountain bracket are possible. For example, although in the embodiments illustrated the figures apertures 210 on arcuate member 204 are illustrated as pre-drilled holes, alternative embodiments of the mounting bracket may be provided free of any holes or apertures. In the case where the mounting bracket is provided free of holes, a user may drill a hole at a desired location on the arcuate member 204 for mounting the mounting bracket to the motor housing.

In addition, although the embodiments discussed make use of a generally cylindrical outer surface 110 for the motor body and corresponding circulate shape for the arcuate member of the mounting bracket, other surfaces shapes, such as octagonal or pentagonal in shape may possible. In such alternative embodiments, the rotation of the mounting bracket about the circumference of the motor body may require that the mounting bracket be disengaged from the motor body, rotated and then re-engaged at the desired angle.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Although embodiments of the present invention have been described in considerable detail, variations and refinements are possible and will become apparent to the person skilled in the art in light of the present description. Therefore, the scope of the invention should be limited only by the appended claims and their equivalents.

1. A motor assembly comprising a motor body having a generally cylindrical outer surface on which is mounted a capacitor via a mounting bracket, wherein the mounting bracket has a generally arcuate member engaging the generally cylindrical outer surface of the motor body and allows the capacitor to be positioned at different angles along a circumference of the motor body by rotating the mounting bracket about the generally cylindrical outer surface of the motor body.

2. The motor assembly defined in claim 1, where the mounting bracket is fastened to the motor body using at least one mechanical fastener thereby positioning the capacitor at a specific angle along the circumference of the motor body.

3. The motor assembly defined in claim 2, wherein the at least one mechanical fastener includes a screw.

4. The motor assembly defined in claim 2, wherein the mounting bracket includes at least two apertures formed along the generally arcuate member, the at least two apertures including a first aperture and a second aperture configured for receiving therein the at least one mechanical fastener.

5. The motor assembly defined in claim 4, wherein the mounting bracket is fastened to the motor body by a screw engaging:
a. one of the at least two apertures of the mounting bracket; and
b. a complementary aperture formed on the outer surface of the motor body.

6. The motor assembly defined in claim 4, wherein the generally cylindrical outer surface of the motor body has an aperture formed thereon, wherein:
a. to position the capacitor at a first specific angle along the circumference of the motor body, the mounting bracket is rotated about the generally cylindrical outer surface of the motor body in order to align the first aperture of the mounting bracket with the at least one aperture defined on the outer surface of the motor body; and
b. to position the capacitor at a second specific angle along the circumference of the motor body, the mounting bracket is rotated about the generally cylindrical outer surface of the motor body in order to align the second aperture of the mounting bracket with the at least one aperture defined on the outer surface of the motor body.

7. The motor assembly defined in claim 4, wherein the at least two apertures includes three or more apertures and wherein the three or more apertures are spaced at a generally regular interval along the arcuate member of the mounting bracket.

8. The motor assembly defined in claim 1, wherein guiding rails are defined on the generally cylindrical outer surface of the motor body to facilitate rotation of the mounting bracket about the generally cylindrical outer surface of the motor body.

9. The motor assembly defined in claim 1, wherein an inner surface of the generally arcuate member of the mounting bracket defines guiding rails configured for matingly engaging corresponding guiding rails defined on the generally cylindrical outer surface of the motor body.

10. The motor assembly defined in claim 9, wherein the guiding rails of the arcuate member of the mounting bracket are oriented longitudinally along at least one side of the inner surface of the generally arcuate member and wherein the corresponding guiding rails defined on the generally cylindrical outer surface of the motor body are oriented along at least a portion of the circumference of the motor body to facilitate rotation of the mounting bracket about the generally cylindrical outer surface of the motor body.

11. The motor assembly defined in claim 1, wherein an inner surface of the generally arcuate member of the mounting bracket defines one or more positioning members configured for engaging corresponding positioning members defined on the generally cylindrical outer surface of the motor body.

12. The motor assembly defined in claim 11, wherein the one or more positioning members of the arcuate member include at least one elongated member extending generally transversely across the inner surface of the arcuate member and wherein the positioning members defined on the generally cylindrical outer surface of the motor body are oriented transversely to the circumference of the motor body to facilitate positioning of the mounting bracket to the motor body.

13. The motor assembly defined in claim 1, wherein the mounting bracket further comprises a capacitor housing member for engaging the capacitor.

14. The motor assembly defined in claim 1, wherein the motor assembly is a pump motor.

15. A mounting bracket for a motor capacitor configured to be used in a motor assembly having a motor body with a generally cylindrical outer surface, the mounting bracket having a generally arcuate member for engaging the generally cylindrical outer surface of the motor body to allow the capacitor to be positioned at different angles on the motor body by rotating the mounting bracket about the generally cylindrical outer surface of the motor body.

16. The mounting bracket defined in claim 15, wherein the mounting bracket is configured to be fastened to the motor body using at least one mechanical fastener to position the capacitor at a specific angle along the circumference of the motor body.

17. The mounting bracket defined in claim 16, wherein the at least one mechanical fastener includes a screw.

18. The mounting bracket defined in claim 16, comprising at least two apertures formed along the generally arcuate member, the at least two apertures including a first aperture and a second aperture configured for receiving therein the at least one mechanical fastener.

19. The mounting bracket defined in claim 18, wherein the mounting bracket is configured to be fastened to the motor body by a screw engaging:
a. one of the at least two apertures of the mounting bracket; and
b. a complementary aperture formed on the outer surface of the motor body.

20. The mounting bracket defined in claim 18, wherein the at least two apertures includes three or more apertures and wherein the three or more apertures are spaced at a generally regular interval along the arcuate member of the mounting bracket.

21. The mounting bracket defined in claim 15, wherein an inner surface of the generally arcuate member of the mounting bracket defines guiding rails configured for matingly engaging corresponding guiding rails defined on the generally cylindrical outer surface of the motor body.

22. The mounting bracket defined in claim 21, wherein the guiding rails of the arcuate member of the mounting bracket are oriented longitudinally along at least one side of the inner surface of the generally arcuate member.

23. The mounting bracket defined in claim 15, wherein an inner surface of the generally arcuate member of the mounting bracket defines one or more positioning members configured for engaging corresponding positioning members defined on the generally cylindrical outer surface of the motor body.

24. The mounting bracket defined in claim 23, wherein the one or more positioning members of the arcuate member include at least one elongated member extending generally transversely across the inner surface of the arcuate member.

25. The mounting bracket defined in claim 15, wherein the mounting bracket further comprises a capacitor housing member for engaging the capacitor.
